(19) United States
(12) Patent Application Publication
(10) Pub. No.: US 2017/0090881 A1
(43) Pub. Date: Mar. 30, 2017

(54) METHODS AND DEVICES FOR EXECUTING PROGRAM CODE OF A PROBABILISTIC PROGRAMMING LANGUAGE

(71) Applicant: Oxford University Innovation Limited, Oxford (GB)

(72) Inventors: Frank Wood, Oxford (GB); Timothy Brooks Paige, Oxford (GB); Vikash Kumar Mansinghka, Cambridge, MA (US); Jan Willem Van De Meent, Cambridge, MA (US); Lurii Perov, Oxford (GB)

(73) Assignee: Oxford University Innovation Limited, Oxford (GB)

(21) Appl. No.: 15/126,916

(22) PCT Filed: Mar. 18, 2015
(86) PCT No.: PCT/GB2015/050795

§ 371 Date: Sep. 16, 2016

Related U.S. Application Data
(60) Provisional application No. 61/954,803, filed on Mar. 18, 2014.

(51) Int. Cl. G06F 9/44; G06F 17/18

(52) U.S. Cl. CPC G06F 8/31; G06F 17/18

(57) ABSTRACT

A method, implemented on at least one computing device, for executing program code of a probabilistic programming language. The program code comprises a series of statements including random procedures for which values are determined when the random procedures are executed, and constraints on results obtained when executing the program code. An execution history for the program code comprises a stored set of values provided for random procedures during execution of the program code. The method comprises generating a plurality of execution histories for the program code. A subset of execution histories from a set comprising the plurality of generated execution histories is determined, using at least one constraint of the program code. At least one new execution history is generated by copying the at least one execution history, and the steps are then repeated using the determined subset of execution histories and the at least one new execution history.

### FIELD OF THE INVENTION

The present invention concerns methods and devices for executing program code of a probabilistic programming language. More particularly, but not exclusively, the invention concerns methods of executing program code of a probabilistic programming language by considering execution histories for the program code.

### BACKGROUND OF THE INVENTION

Probabilistic programming is a relatively recently devised style of computer programming. With conventional computer program execution, the general principle is that a program and an input for the program are provided, and the program is executed using the input in order to produce an output. In contrast, with probabilistic programming the general principle is that a partially specified program and an output for the program are provided, and “executing” a probabilistic program involves finding ways the program could be executed (e.g. including, but not limited to, parameters and internal variables that the program uses when executing that are not fully specified in the program itself) for the program that result in the provided output.

Functionality to perform probabilistic programming may be provided by a toolkit for use with an existing programming language (e.g. a library of probabilistic programming functions that can be called by programs written in the language), or by a dedicated probabilistic programming language, i.e. programming language that is specifically intended to be used for probabilistic programming. Known probabilistic programming languages/toolkits include Church (N. Goodman, V. Mansinghka, D. Roy, K. Bonawitz, J. Tenenbaum; Church: a language for generative models; Proc. Uncertainty in Artificial Intelligence 2008), IBAL (A. Pfeffer; IBAL: A Probabilistic Rational Programming Language; Proc. 17th International Joint Conference on Artificial Intelligence (IJCAI), 2001, 733-740) and Figaro (A. Pfeffer; Figaro: An object-oriented probabilistic programming language; Charles River Analytics Technical Report, 2009), amongst others.

It can be a disadvantage of known probabilistic programming languages/toolkits that they do not execute efficiently, and in particular are not suited to efficient execution on modern general purpose computer architectures. Another disadvantage is that are not suited to parallel execution across multiple separate processors/computers, to allow execution-intensive tasks to be efficiently processed.

The present invention seeks to solve and/or mitigate the above-mentioned problems. Alternatively and/or additionally, the present invention seeks to provide improved methods and devices for executing program code of a probabilistic programming language.

### SUMMARY OF THE INVENTION

In accordance with a first embodiment of the invention there is provided a method, implemented on at least one computing device, for executing program code of a probabilistic programming language, wherein the program code comprises a series of statements including:

random procedures for which values are determined when the random procedures are executed; and

constraints on results obtained when executing the program code;

wherein an execution history for the program code comprises a stored set of values provided for random procedures during execution of the program code;

and wherein the method comprises generating a plurality of execution histories for the program code, by iterating the steps of:

a1) for each of the plurality of generated execution histories, executing at least one statement of the program code using the values stored in the generated execution history, and, if the statement is a random procedure, providing a value for the random procedure and storing the value in the generated execution history;

a2) determining a subset of execution histories from a set comprising the plurality of generated execution histories, using at least one constraint of the program code;

a3) determining at least one execution history to copy from the set comprising the plurality of generated execution histories, using at least one constraint of the program code, and generating at least one new execution history by copying the at least one execution history; and

a4) repeating step a1) and subsequent steps using the determined subset of execution histories and the at least one new execution history.

In accordance with the method, a plurality of execution traces are generated for the program code, and the constraints are used to determine which execution traces should be copied, and which should no longer be executed (i.e. are not selected to be in the subset of execution traces that continue to be executed). In this way, a set of execution traces is iteratively selected, based upon how their execution state compares with the constraints of the program. The set of execution traces that survive can therefore be seen as those execution traces that best satisfy a “fitness” criteria. The execution traces that are selected may be those that best satisfy the constraints of the program, but preferably more general fitness criteria are used.

An execution trace is the sequence of memory states (e.g. virtual memory, register state, stack frames, heap and allocated memory contents) that arise during the sequential execution of the program code. As the lines of a program can depend upon the values chosen for random variates, a set of lines can have different execution traces corresponding to different values chosen for the random variates.

This method has been found to be particularly efficient at exploring the execution histories that match the constraints of a program.

A statement of the programming language may be any executable unit of the language, for example a function, directive or the like, depending on syntax of the programming language. A random procedure may be a pre-defined statement of the programming language (e.g. a keyword/reserved word), or may be defined in the program code.

The value for a random procedure may be determined using a truly random or a pseudo-random procedure.

The method may comprise iterating the steps of:

z) obtaining a retained execution history for the program code;

a) iteratively performing the steps a1) to a4), wherein in steps a2) and a3) the subset and the execution history to copy are determined from the set comprising the retained execution history and the generated execution histories;

b) determining an execution history to retain from the set comprising the retained execution history and generated execution histories, using at least one constraint of the program code; and

c) repeating step a) and subsequent steps using the determined execution history as the retained execution history. The iteration of these steps has the effect that the retained execution history is the current “fittest” execution history. Each time the subset of execution traces is determined, a copy of the retained execution history is added to the subset, and so if the subset already included the retained execution history, there will now be a further copy. In this way, a retained execution history that continues to be the “fittest” of the execution histories will come to dominate the set execution histories being generated. A new “fittest” execution history is then selected from the finished set of generated execution histories, and the entire process is repeated using the newly selected execution history as the retained execution history.

Alternatively, the method further comprises iterating the steps of:

generating a set of execution histories by performing the steps a1) to a4);

obtaining output values for the set of execution histories;

determining whether to retain the output values for the set of execution histories or retained output values for a previously generated set of execution histories. This is an alternative method for iterating the method described above. The determination whether to retain the output values for the set of execution histories may be performed using the constraints in the program code, by comparing the “fitness” of the new set of execution histories with the “fitness” of the set of execution histories for the retained output values. Marginal likelihood can be used as the fitness criteria for sets of execution histories, but preferably more general criteria for fitness of execution histories are used. Thus, sets of execution histories are iteratively generated, and at each iteration the output values for the set are retained if the set of execution histories are determined to be “better” than the set of execution histories for the retained output values.

Advantageously, an execution history further comprises a stored set of weights indicating how well constraints in the program code have been met by the values provided for the random procedures; in step a1), if the statement is a constraint, the step includes determining a weight indicating how well the defined constraint has been met by the execution of the copy of the code and storing the weight in the execution history; and, in steps a2) and a3) the determination is made using the weights stored in the execution histories. This allows the determinations of execution histories using the constraints of the program code to be efficiently performed. Similarly, advantageously the determination of the execution history to retain in step b) is made using the weights stored in the execution histories.

Preferably, the program code further comprises statements including: monitoring procedures to return values when executed; and in step a1), if the statement is a monitoring procedure, the step includes returning a value determined using the values stored in the execution history. This allows the result of executing the program code to be obtained and analysed; the values may for example be printed out or stored in a file. The monitoring procedures may provide the output values in the method described above, in which it is determined whether to retain the output values for the current set of execution histories or the retained set of output values for a previously generated set of execution histories.

Preferably, in step a2) the determination uses every constraint that has been executed while generating the execution history. Similarly, preferably in step b) the determination uses every constraint in the program code.

Preferably, at least one random procedure is defined in terms of a random distribution. Examples of random distributions include a random bit, the normal distribution, Poisson distribution, discrete distribution, Dirac delta function and the like. The program code may include parameters further defining the random distribution, for example a mean and variance for a normal distribution.

Preferably, at least one constraint is defined in terms of a random distribution and a corresponding value, and how well the constraint is met is determined by calculating the likelihood of the random distribution returning the corresponding value. More preferably, a plurality of constraints are defined in terms of a random distribution and a corresponding value, and how well the plurality of constraints are met is determined by calculating the combined likelihood of the random distributions returning their corresponding values.

The plurality of new execution histories may be generated using distinct system processes, and the generating may include the step of copying at least one of the distinct system processes. In this case, advantageously the step of copying is performed using a dedicated operating system command. For example, a POSIX fork command can advantageously be used to create a new system process. Advantageously, the dedicated operating system command calls a dedicated hardware command for copying a system process implemented in the hardware of the at least one computing device. Advantageously, the hardware of the at least one computing device is optimised to efficiently implement the dedicated hardware command. The hardware may be dedicated hardware for executing the method of the invention. Alternatively, the hardware may be general-use hardware (i.e. hardware not specifically designed for use with the invention) that is optimised for use with the method of the invention.

Alternatively, the plurality of new execution histories may be generated using distinct threads. The threads may be provided by threading functionality of the language in which the computer program implementing method is written. Alternatively, the plurality of new execution histories may be generated, and in particular the corresponding execution, memory management and the like explicitly handled, by the program itself. It will be appreciated that other methods for efficiently managing the multiple execution histories could be used in accordance with the invention, whether using existing system functionality for managing multiple processes/threads/CPUs, or using functionality specifically provided for use with the invention.

A first and a second new execution history may be generated by a first and a second computing device.

In accordance with a second embodiment of the invention there is provided a least one computing device arranged to perform any of the methods described above.

Advantageously, the at least one computing device comprises hardware arranged to perform a dedicated command to copy a system process.

In accordance with a third embodiment of the invention there is provided a program product arranged, when executed on at least one computing device, to perform any of the methods described above.

In accordance with a fourth embodiment of the invention there is provided a computer program product arranged, when executed on at least one computing device, to provide any of the at least one computing devices described above.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows an algorithm according the embodiment of the invention;

FIG. 2 shows an algorithm according to another embodiment of the invention;

FIGS. 3a and 3b show an algorithm according another embodiment of the invention;

FIG. 4 is a flowchart showing the steps of the algorithm of FIGS. 3a and 3b.

### DETAILED DESCRIPTION

A probabilistic programming language and execution method in accordance with an embodiment of the invention are now described. The language is a probabilistic programming intermediate representation language, which can be compiled to machine code by standard compilers, and linked to operating system libraries. Thus, it can be used as an efficient, scalable and portable probabilistic programming compilation target. (In other words, compilers for probabilistic programming languages can be provided that compile programs in a probabilistic programming language into a program in the intermediate representation language, which can then be efficiently/scalably/portably executed.)

However, it will be understood that the invention is not restricted to the programming language now described, and is equally applicable to programming languages with alternative syntaxes, for example new or known probabilistic programming languages which are generally used directly by a user, rather than as an intermediate language into which another language is compiled.

The intermediate representation language of the embodiment is provided by the well-known programming language C, along with a library “probabilistic.h” of two functions, observe and predict (or predictf). The library also provides various probabilistic functions, including random variates that provide values in accordance with defined probability distributions, and probability density functions that compare values with defined probability distributions.

An observe function conditions the execution of the program, based upon a probability density function provided by the library. The probability density function will take some number of parameters (possibly zero), and an expression; the observe function then indicates that the expression should match result of the probability density function, in the sense that the probability density function provides a measure for how “close” the expression is to a desired value.

A predict allows values obtained during execution to be observed.

The library also includes macros that rename main and wrap it in a function that performs the execution method of this embodiment of the invention. In other words, when main is run, it does not simply execute the code it contains as would usually be the case; rather, the execution method is performed upon the code defined within main.

Considering again the general principle of probabilistic programming that a program and output are provided and the input is found, in practice the desired “output” is given by the observe directives, and the “input” is given by the particular values any random variates produce during execution. Execution of the program in essence means trying to find values for the random variates that meet the constraints given by the observe functions, using predict functions to monitor the results of the evaluation as it happens.

An example of a simple program is as follows:

```
#include “probabilistic.h”
double square(double n) {
    return n * n;
}
int main(int argc, char **argv) {
    double i = normal_rng(5, 2);
    observe(normal_lnp(20, square(i), 1));
    predict(“i %f\n”, i);
    return 0;
}
```

This program defines that:
square is a function that squares its input;
i is a random variate normal_rng which has normal distribution, mean 5 and standard deviation 2;
the random distribution function normal_lnp returns the natural logarithm of the probability that its first argument is the value given by a normal distribution with mean and standard deviation given by the second and third arguments; so in the program the observed constraint is that the normal distribution with mean square(i) and standard deviation 1 should return the value 20;
values for i are monitored.

(In an alternative embodiment, the functions normal_rng and normal_lnp take a parameter that defines their variance rather than standard deviation.)

Execution of the program then reports values for i with frequency proportional to how well the constraint that square(i) evaluates to 20 is satisfied; in other words, the values of i that execution of the program will report most often are those close to the square root of 20. The random variate normal_rng(5, 2) with which i is defined gives the range of values from which possible values for i are selected, and the random distribution function normal_lnp(20, square(i), 1)) used in the observe directive determines how “close” the actual value of (square i) is to the desired value 20; as explained below, this allows the inputs that best satisfy the constraints to be homed in on during execution.

The execution method of the present embodiment is now described. The execution method involves deriving multiple execution traces, where an execution trace is defined to be the sequence of memory states (virtual memory, register state, stack frames, heap and allocated memory contents) that arise during the sequential execution of the program code within main. As the lines of a program can depend upon the values chosen for random variates, a set of lines can have different execution traces corresponding to different values chosen for the random variates.

A program will have N observe functions, with associated observed data points y₁, to y_{N} (given the expressions within the observe functions). During a single run of a program, some number N′ of random choices x₁′ to x_{N′}′ of values for random variates will be made. The observations yₙ can appear at any point in a program, and so define a partition of random choices x_{1:N′}′ into N subsequences x_{1:N}, where each xₙ contains all random choices made up to observing yₙ but excluding any random choices prior to yₙ₋₁. The probability of a single execution trace is then defined as

$$p ( {y}_{1 : N} , {x}_{1 \text{:} N} ) = {\prod }_{n = 1}^{N} g ( {y}_{n} \vert {x}_{1 \text{:} n} ) f ( {x}_{n} \vert {x}_{1 \text{:} n - 1} )$$

Each observe statement takes as its input ln g(yₙ|x_{1:n}). Each quantity of interest in a predict statement corresponds to some deterministic function h(•) of all random choices x_{1:N} made during execution of the program. Given a set S or posterior samples {x_{1:N}^{(s)}}, the posterior distribution of h(•) can be approximated as

$$h ( {x}_{1 \text{:} N} ) \approx \frac{1}{S} {\sum }_{s = 1}^{S} h ( {x}_{1 \text{:} N}^{( s )} )$$

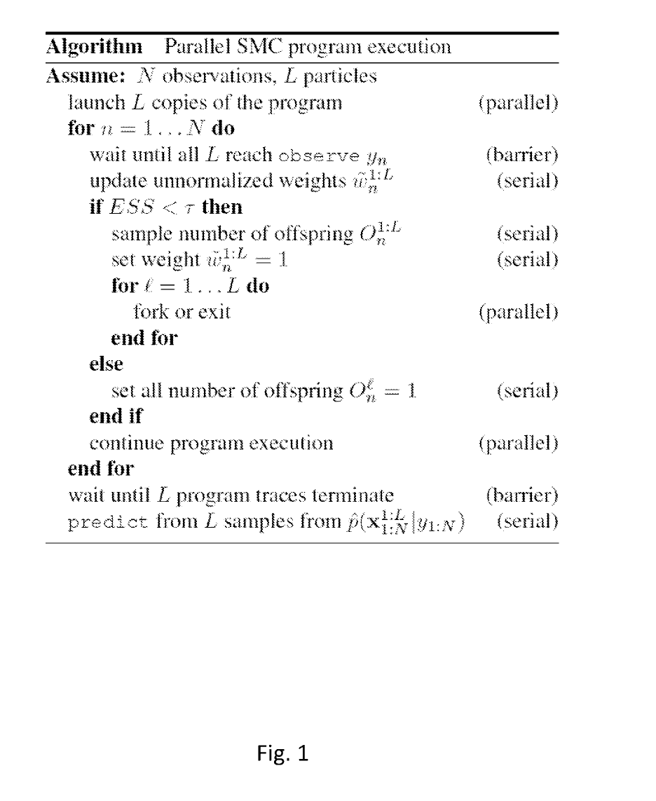

The execution method of the present embodiment is shown in FIG. 1. The (parallel) labels indicate code that can be executed in parallel, (barrier) labels indicate when it may be necessary to wait for execution of all parallel processes to complete before performing the next line of code, and (serial) labels indicate code that must be executed serially.

The execution method uses an algorithm based upon parallel execution of L copies of the program, to perform Sequential Monte Carlo (SMC, sequential importance resampling). In essence, multiple copies of the program (called “particles”) are run, and executions that match the required conditions (as defined by the observe statements) are reported.

SMC approximates a target density p(x_{1:N}|y_{1:N}) as a weighted set of L realised trajectories such that

$$p ( {x}_{1 : N} \vert {y}_{1 \text{:} N} ) \approx {\sum }_{𝓁 = 1}^{L} {ω}_{N}^{𝓁} {δ}_{{x}_{1 \text{:} N}^{𝓁}} ( {x}_{1 \text{:} N} ) .$$

To make this approximation tractable, using (for n=1) the recursive identity

p(x_{1:n}|y_{1:n})−p(x_{1:n-1}|y_{1:n-1})g(yₙ|x_{1:n})f(xₙ|x_{1:n-1}),

p(x_{1:N}|y_{1:N}) is sampled from by iteratively sampling from each p(x_{1:n}|y_{1:n}) in turn, for n from 1 to N. At each n, an importance sampling distribution is constructed from the execution of the program, i.e. each of the sequence of random variates xₙ is jointly sampled from the program execution state dynamics

xₙ^{l}˜f(xₙ|x_{1:n-1}^{α}^{ₙ₋₁}^{^{l}})

where αₙ₋₁^{l} is an “ancestor index”, the particle index 1 to L of the parent at time n−1 of xₙ¹. The unnormalised particle importance weights at each observation yₙ are the observe data likelihood

\tilde{w}ₙ^{l}=g(y_{1:n},x_{1:n}^{l})

which is normalised as

$${w}_{n}^{𝓁} = \frac{{\tilde{w}}_{n}^{𝓁}}{{\sum }_{𝓁 = 1}^{L} {\tilde{w}}_{n}^{𝓁}} .$$

Thus, after each step n there is a weighted set of execution traces which approximate p(x_{1:n}|y_{1:n}). As the program executes, traces which do not match the desired data well will have weights which become negligibly small. In a worst-case this can lead to all weight being concentrated in a single execution trace. To counteract this deficiency, the current set of L execution traces l is resampled if the effective sample size ESS

$$ESS \approx \frac{1}{{\sum }_{𝓁} {( {w}_{n}^{𝓁} )}^{2}}$$

is less than a suitable threshold τ, τ=l/2 for example. The execution traces l are resampled according to their weights wₙ¹ after each observation yₙ. This is done by sampling a count Oₙ¹ for the number of “offspring” of a given execution trace 1 to be included at time n+1. The sampling scheme must ensure that the expected value [symbol] [Oₙ¹]=wₙ¹. Sampling offspring counts Oₙ¹ is equivalent to sampling ancestor indices aₙ¹. Execution traces with no offspring are killed, and those with more than one are forked the appropriate number of times. After resampling, all weights wₙ¹=1.

In alternative embodiments, resampling is performed at different intervals.

As can be seen from FIG. 1, L copies of the program are launched. All are executed until an observe yₙ is reached, and when all have reached their unnormalised weights are updated. If the effective sample size (ESS) is below the threshold τ, the resampling is performed. The execution of each copy of the program is then continued until the observe is reached, and resampling is performed if required. This is repeated until each program terminates, and then values are samples for the predict statements, and output as required.

If desired, the whole process can be repeated, independently of any previous execution, to provide a new batch of samples.

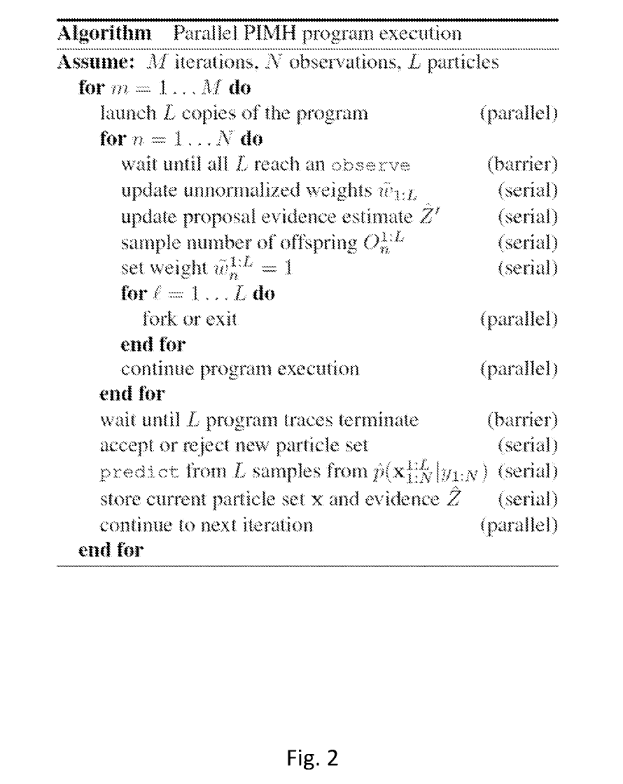

An execution method in accordance with an alternative embodiment of the invention is now described. The execution method is based upon particle Markov chain Monte Carlo (PMCMC), as described in C. Andrieu, A. Doucet and R. Holenstein; Particle Markov chain Monte Carlo methods. Journal of the Royal Statistical Society: Series B Statistical Methodology), 72(3):269-342, 2010. In particular, it is based upon the particle independent Metropolis-Hastings (PIMH) variant. Essentially, the execution method iterates the SMC procedure. The execution method is shown in FIG. 2.

After running a single iteration of SMC to generate a set of particles, an estimate of the marginal likelihood is computed

$$\hat{Z} ≡ p ( {y}_{1 \text{:} N} ) \approx {\prod }_{n = 1}^{N} [ \frac{1}{N} {\sum }_{𝓁 = 1}^{L} {w}_{n}^{𝓁} ]$$

Another iteration of sequential Monte Carlo is then run to generate a new set of particles. This new set is used as a proposal, and the marginal likelihood \hat{Z}′ of the proposed new set is estimated. The proposed new set is accepted with probability

min(1,\hat{Z}′/\hat{Z})

If accepted, a new set of predict samples are obtained from the new particle set and output, otherwise the same predict samples as obtained from the previous set are output.

As can be seen from FIG. 2, the inner loop of the execution method is similar to SMC as in the previous embodiment.

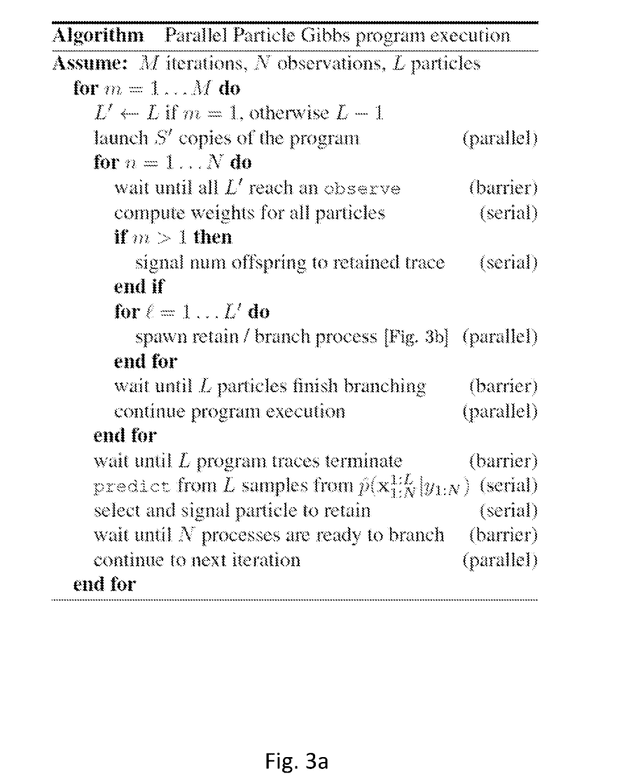

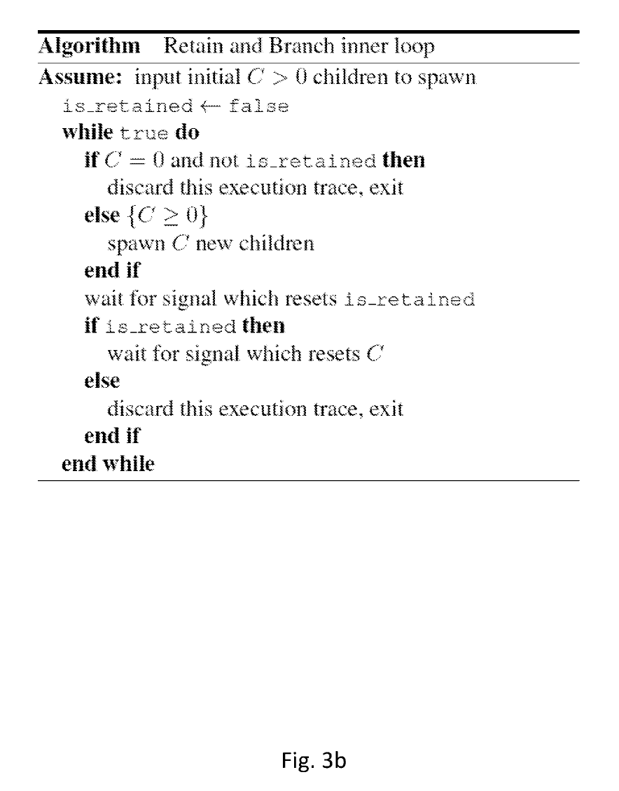

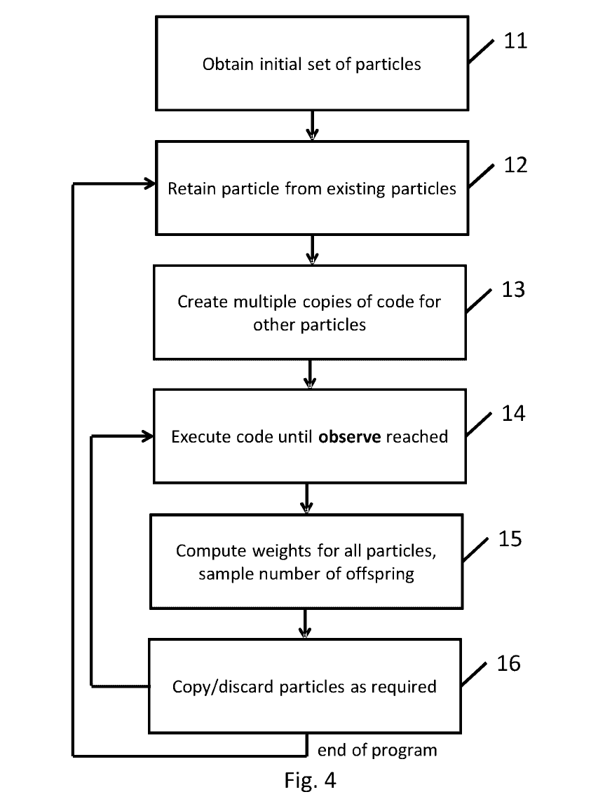

An execution method in accordance with another alternative embodiment of the invention is now described. The execution method is based upon the Particle-Gibbs (PG) variant of PMCMC. Again, essentially the execution method iterates the SMC procedure. The execution method is shown in FIGS. 3a and 3b, and described with reference to FIG. 4.

As shown in FIG. 4, first an initial set of L particles are generated (step 11), by running L copies of the program. A particle is retained from the set of particles, by sampling a single particle from the set of particles (step 12).

L−1 copies of the code are then created for the remaining particles (step 13). In one embodiment, the execution, memory management and the like for the copies of the program are handled explicitly by the code providing the library for the execution method itself. However, in alternative embodiments threading functionality provided by the underlying programming language can be used. This means that the details of memory management and the like are left to the underlying language, which can be advantageous due to its simplicity, and because there may be thread processing optimisations that are unavailable from within the language itself (e.g. by taking account of details of memory use that can be observed by a complier/interpreter but are not visible to a program in the language). However, it can be disadvantageous as the aspects of the processing of the code in the threads necessarily cannot be controlled. In further alternative embodiments, separate operating system processes can be used for the copies of the program. This cedes even more control to the operating system, with similar potential advantages and/or disadvantages as discussed above.

The code is then executed in each particle until an observe statement is reached (step 14). Once all particles have reached an observe, weights for all particles are computed, and the number of offspring Oₙ¹ each particle should have is sampled (step 15). Importantly, only L−1 new offspring are sampled, so that the retained particle can always have at least one offspring. Further, the resampling (selecting offspring and resetting weights wₙ¹=1) must be done after every observe in order to properly align the retained particle on the next iteration through the program.

Particles are then copied or discarded as required (step 16). This is performed by a retain/branch loop for each particle as shown in FIG. 3b. If a particle is to have no offspring and is not the retained particle, the execution trace is discarded and the loop exits; otherwise the number of offspring it is to have are spawned by making copies. The spawned child particles (and the original particle which arrived at the observe barrier) wait (albeit briefly) at a new barrier marking the end of observe n, not continuing execution until all new child processes have been launched.

The steps of executing code in each particle until another observe is reached, computing weights and sampling offspring, and copying/discarding particles are iterated (steps 14 to 16).

When execution of code in each particle is complete, and the final set of weights computed, the required predict samples are obtained and output (not shown in FIG. 4). A new particle is selected to be retained from the set of particles (step 12 again), by sampling (according to weight) from the final particle set to select a single particle to retain during the next SMC iteration. When the particle is selected, as shown in FIG. 3b a signal is broadcast to each retain/branch loop, indicating which particle is to be retained (e.g. by indicating its process ID). All loops except for the loop for the retained particle then discard their execution traces and exit.

While the present invention has been described and illustrated with reference to particular embodiments, it will be appreciated by those of ordinary skill in the art that the invention lends itself to many different variations not specifically illustrated herein.

For example, the skilled person will appreciate that the invention applies equally to embodiments in which the program code that is executed to find the desired execution traces is program code written directly by a user, for example code of a dedicated probabilistic programming languages, rather than being complied code in an intermediate representation language.

1. A method, implemented on at least one computing device, for executing program code of a probabilistic programming language, wherein the program code comprises a series of statements including:
random procedures for which values are determined when the random procedures are executed; and
constraints on results obtained when executing the program code;
wherein an execution history for the program code comprises a stored set of values provided for random procedures during execution of the program code;
and wherein the method comprises generating a plurality of execution histories for the program code, by iterating the steps of:
a1) for each of the plurality of generated execution histories, executing at least one statement of the program code using the values stored in the generated execution history, and, if the statement is a random procedure, providing a value for the random procedure in accordance with a predetermined method and storing the value in the generated execution history;
a2) determining a subset of execution histories from a set comprising the plurality of generated execution histories, using at least one constraint of the program code;
a3) determining at least one execution history to copy from the set comprising the plurality of generated execution histories, using at least one constraint of the program code, and generating at least one new execution history by copying the at least one execution history; and
a4) repeating step a1) and subsequent steps using the determined subset of execution histories and the at least one new execution history.

2. A method as claimed in claim 1, wherein the method comprises iterating the steps of:
z) obtaining a retained execution history for the program code;
a) iteratively performing the steps a1) to a4), wherein in steps a2) and a3) the subset and the execution history to copy are determined from the set comprising the retained execution history and the generated execution histories;
b) determining an execution history to retain from the set comprising the retained execution history and generated execution histories, using at least one constraint of the program code; and
c) repeating step a) and subsequent steps using the determined execution history as the retained execution history.

3. A method as claimed in claim 1, wherein the method further comprises iterating the steps of:
generating a set of execution histories by performing the steps a1) to a4);
obtaining output values for the set of execution histories;
determining whether to retain the output values for the set of execution histories or retained output values for a previously generated set of execution histories.

4. A method as claimed in claim 1, wherein an execution history further comprises a stored set of weights indicating how well constraints in the program code have been met by the values provided for the random procedures; in step a1), if the statement is a constraint, the step includes determining a weight indicating how well the defined constraint has been met by the execution of the copy of the code and storing the weight in the execution history; and, in steps a2) and a3) the determination is made using the weights stored in the execution histories.

5. A method as claimed in claim 1, wherein the program code further comprises statements including:
monitoring procedures to return values when executed;
and wherein in step a1), if the statement is a monitoring procedure, the step includes returning a value determined using the values stored in the execution history.

6. A method as claimed in claim 1, wherein in step a2) the determination uses every constraint that has been executed while generating the execution history.

7. A method as claimed in claim 1, wherein at least one random procedure is defined in terms of a random distribution.

8. A method as claimed in claim 1, wherein at least one constraint is defined in terms of a random distribution and a corresponding value, and how well the constraint is met is determined by calculating the likelihood of the random distribution returning the corresponding value.

9. A method as claimed in claim 8, wherein a plurality of constraints are defined in terms of a random distribution and a corresponding value, and how well the plurality of constraints are met is determined by calculating the combined likelihood of the random distributions returning their corresponding values.

10. A method as claimed in claim 1, wherein the plurality of new execution histories are generated using distinct system processes, and the generating includes the step of copying at least one of the distinct system processes.

11. A method as claimed in claim 10, wherein the step of copying at least one of the distinct processes is performed using a dedicated operating system command for copying a system process.

12. A method as claimed in claim 9, wherein the dedicated operating system command calls a dedicated hardware command for copying a system process implemented in the hardware of the at least one computing device.

13. A method as claimed in claim 12, wherein the hardware of the at least one computing device is optimised to efficiently copy a system process.

14. A method as claimed in claim 1, wherein a first and a second new execution history are generated by a first and a second computing device.

15. At least one computing device arranged to perform the method of claim 1.

16. At least one computing device as claimed in claim 15, comprising hardware arranged to perform a dedicated command to copy a system process.

17. A computer program product arranged, when executed on at least one computing device, to perform the method of claim 1.

18. (canceled)
